(19) United States
(12) Patent Application Publication
(10) Pub. No.: US 2010/0147227 A1
(43) Pub. Date: Jun. 17, 2010

(54) Motivational Object

(75) Inventor: Ekard Lind, Mettersdorf (AT)

Correspondence Address: Ashok Tankha, 36 Greenleigh Drive, Sewell, NJ, 08080, US

(73) Assignee: Elation Inc.

(21) Appl. No.: 12/636,783

(22) Filed: Dec. 14, 2009

(30) Foreign Application Priority Data
Dec. 16, 2008 (DE) 10 2008 063 898.6

(51) Int. Cl. A01K 15/02

(52) U.S. Cl. 119/709

(57) ABSTRACT

To provide a motivational training device for dogs, including a bite body made of an elastomeric material, with a first outer annular bulge, a second outer annular bulge and at least one more annular bulge arranged in-between the first and the second outer annular bulge, whereby the annular bulges are arranged in parallel in the longitudinal direction of the bite body, to prevent the undesirable slipping of the dog off the motivational object, to guarantee an undisturbed joy of gameplay with the device on one hand, and a flawless dog training experience from a sporting and working dog perspective on the other hand, it is proposed to including a plurality of troughs in the circumferential area of the bite body arranged in-between the adjoining annular bulges.

### CROSS REFERENCE TO RELATED APPLICATIONS

This application claims the benefit of non-provisional patent application number 10 2008 063 898.6 titled “Motivational Object”, filed on Dec. 16, 2008 in the German Patent And Trade Mark Office.

The specification of the above referenced patent application is incorporated herein by reference in its entirety.

### TECHNICAL FIELD OF THE INVENTION

This invention relates to animal training devices, and more specifically to a motivational training device for dogs including a bite body made of an elastomeric material with a first outer annular bulge, a second outer annular bulge and at least one more annular bulge arranged in-between the first outer annular bulge and the second outer annular bulge whereby the annular bulges are arranged in parallel in the longitudinal direction of the bite body.

### BACKGROUND

Motivational objects for dogs, such as the device described in German patent DE 298 19 615 U1, are state-of-the-art. These devices allow a dog to grip the bite body in-between its annular bulges, thereby effectively preventing the dog's teeth from side-slipping in a longitudinal direction of the device. The annular bulges however do not prevent the dog's teeth from slipping in a direction perpendicular to the longitudinal direction of the device.

### SUMMARY OF THE INVENTION

This purpose of this invention is to prevent the undesirable slipping of the dog off the motivational object to guarantee an undisturbed joy of gameplay with the device on one hand, and a flawless dog training experience from a sporting and working dog perspective on the other hand.

According to the present invention, this challenge is met by including a plurality of troughs in the circumferential area of the bite body arranged in-between the adjoining annular bulges.

“Annular bulges”, as used in this description and the patent claims are substantially annular bulges of the bite body. Preferably, several annular bulges are arranged side by side, and are oriented perpendicular to the longitudinal direction of the bite body.

A preferred form of the motivational object according to the invention comprises of a bite body made of rubber, natural rubber or a similar, rubber-like material; or is coated with rubber, natural rubber or a similar, rubber-like material.

Preferably, utilization of the motivational object according to the invention limits or completely inhibits any “chewing behavior” (after gripping and while carrying the device) on the bite body, which is judged as incorrect or flawed behavior in competitive dog sports and working dog training.

Moreover, the motivational object according to the invention limits or inhibits a dog's desire to “reward itself”, which may distract it while completing dog handler set tasks such as the retrieve or the identifying and returning of objects. “Self rewards” for dogs are, for example, showing-off behaviors, changing the position of the retrieved object in the dogs muzzle or the “chewing behavior” mentioned above.

Preferably, the troughs are formed by the annular bulges and at least one longitudinal web.

A “longitudinal web” as used in this description and the accompanying claims signifies a bulge of the bite body which essentially extends in the longitudinal direction of the bite body.

The motivational object according to the invention comprises of another bulge-system in addition to the annular bulges due to at least one longitudinal web, which preferably extends transversely to the annular bulges known from state-of-the-art motivational objects. This allows a gripping dog to insert its active teeth preferably into the nearest, concave shaped “low points” formed by the longitudinal web in-between the adjoining annular bulges of the motivational object according to the invention, which are identified as “troughs” throughout this description and the accompanying claims, and to hold it tight until the motivational object is released. Once the dog relieves pressure, it feels the loss of a secure grip more than it would with the state-of-the-art device containing only annular bulges. In contradistinction to the state-of-the-art motivational object which only contains one level of holding support for the dog's teeth, the dog's bite sensation with the motivational object according to the invention is much more secure. As a result of the troughs formed by the annular bulges and the longitudinal web, the dog will grip the motivational object according to the invention more firmly and carry it more calmly.

One embodiment of the invention provides that an envelope of the bite body is at least approximately frustoconically shaped.

A further refinement of the invention provides that an envelope of the bite body is at least approximately cylindrically shaped.

An alternative or complementary embodiment of the invention may provide that the bite body is at least approximately spherical or ellipsoidal shaped.

Preferably, at least sectionally, the annular bulges and at least one longitudinal web are arranged radially in a direction perpendicular to the longitudinal direction of the bite body, having a maximum expansion that is essentially equal in size. This approach guarantees a secure grip of the motivational object.

In this respect, provision may be made that the bite body comprises of an essentially uniformly curved outer surface, where at least two annular bulges and at least one longitudinal web are adjoined at the points of their maximum radial extension.

In another embodiment of the invention is provided that, at least sectionally, the annular bulges arranged radially in a direction perpendicular to the longitudinal direction of the bite body have an expansion that is larger than at least one longitudinal web.

An alternative or complementary embodiment of the invention may provide that, at least sectionally, the annular bulges arranged radially in a direction perpendicular to the longitudinal direction of the bite body have an expansion that is smaller than at least one longitudinal web.

It is favorable, if at least one longitudinal web is flattened in the area of its maximum radial extent.

In particular, provision may be made that the cross-section of at least one longitudinal web in a direction perpendicular to the longitudinal direction is essentially trapezoidal shaped.

Alternatively or additionally, it can be provided that at least one longitudinal web is pointed-shaped in the area of its maximal radial extent.

In particular, provision may be made that the cross-section of at least one longitudinal web in a direction perpendicular to the longitudinal direction is essentially V-shaped.

It also can be provided that at least one longitudinal web is rounded off in the area of its maximum radial extent.

In particular, provision may be made that the cross-section of at least one longitudinal web in a direction perpendicular to the longitudinal direction is essentially U-shaped.

It is favorable, if the bite body includes at least two longitudinal webs, which are arranged at a distance of at least approximately 1 mm, particularly at least about 3 mm from each other.

It is particularly favorable, if the bite body includes at least two longitudinal webs which are arranged at a distance of at most approximately 4 mm, particularly at most about 6 mm from each other.

A secure grip of the dog is particularly then guaranteed, if a plurality of essentially symmetrically distributed longitudinal webs are arranged on the bite body.

It is particularly favorable, if the troughs distributed on the circumferential area of the bite body are arranged in a grid-like configuration, i.e. they are equally distributed next to another over the circumference, resulting in a uniform pattern.

In particular, provision may be made that all troughs have at least approximately the same dimensions.

Preferably, the troughs are arranged at an at least approximately constant distance to another.

In another embodiment of the invention is provided that only one line of troughs is arranged in-between its adjacent annular bulges.

A particularly simple handling of the motivational object is made possible with a towing or hurling rope arranged at one abutting face of the bite body.

Alternatively or additionally, it can be provided that at the bite body incorporates an essentially concentrically running longitudinal feed-through, through which a towing or hurling rope can be led.

Other features of the invention are the subject of the following description and the technical drawings.

### BRIEF DESCRIPTION OF THE DRAWINGS

FIG. 1 illustrates a schematic, perspective view of a first embodiment of the motivational object according to the invention, with an essentially conically shaped bite body and a rope arranged at its abutting face.

FIG. 2 illustrates a schematic, perspective view of a second embodiment of the motivational object according to the invention, with an essentially cylindrically shaped bite body and two ropes arranged at both of its abutting faces.

FIG. 3 illustrates a schematic representation of a cross section through the bite body in FIG. 2 between two annular bulges.

FIG. 4 illustrates a schematic representation of a longitudinal cross section through the bite body in FIG. 2.

FIG. 5 illustrates a schematic representation of a cross section through the bite body corresponding to FIG. 3, with a multitude of embodiments of the longitudinal webs.

Identical or functionally equivalent elements are provided with the same reference characters in all figures.

### DETAILED DESCRIPTION OF THE INVENTION

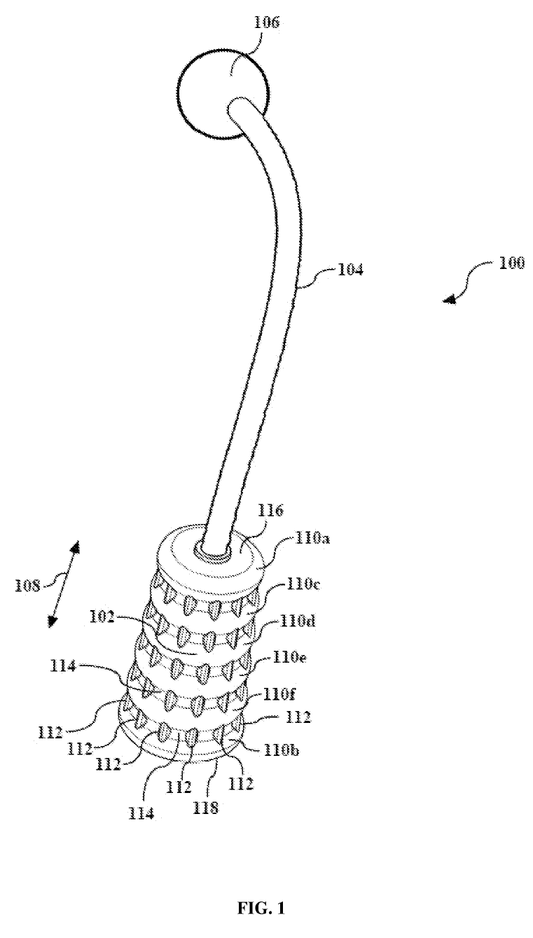

The implementation example of a motivational object 100 shown in FIG. 1 consists of a bite body 102, a rope 104 that may be used for hurling or holding, and a holding device 106. The bite body 102 has an at least approximately conically shaped envelope and several, for example six annular bulges 110, side by side, arranged in a longitudinal direction 108 parallel to the rotational axis of the conically shaped envelope of the bite body 102. There are four annular bulges 110c, 110d, 110e, 110f arranged in-between a first outer annular bulge 110a and a second outer annular bulge 110b.

Several, for example twelve longitudinal webs 112 extend in longitudinal direction 108 between the adjacent annular bulges 110a, 110c; 110c, 110d; 110d, 110e; 110e, 110f; and 110f, 110b.

The longitudinal webs 112 extend in longitudinal direction 108 essentially over the entire length of the bite body 102, i.e. from the first outer annular bulge 110a to the second outer annular bulge 110b.

The annular bulges 110 and the longitudinal webs 112 provide an essentially grid-like pattern on the surface of the bite body 102, forming in one or two directions concave, for example, at least approximately spherical troughs 114 in each case between two annular bulges 110 and two longitudinal webs 112.

A rope 104 is fixed essentially concentrically on one abutting face 116 of the conically shaped bite body 102. The rope 104 has a length of, for example twice the length of the bite body 102 and its end opposite to the end arranged at the abutting face 116 is firmly connected to a holding device 106, which for example, could have a spherical shape.

The bite body 102 is, depending on its design for different breeds, for example between 5 cm and 12 cm in length and has a diameter of, for example 2.5 cm to 4.5 cm on its abutting face 116, and has a diameter of, for example 3 cm to 6 cm on a basal area 118 located on the side opposite to the side of the abutting face 116 on the bite body 102.

Provision may be made that the annular bulges 110 have essentially sinus shaped waists. Alternatively, provision may be made that the annular bulges 110 are formed by essentially into another merging sections of spheres with pointed waists.

The motivational object 100 described herein is used as follows:

A dog handler grasps the holding device 106 of the motivational object 100 and hurls the motivational object 100 away by means of a movement of the arm.

This motivates the handler's dog to run after the motivational object 100 and to catch it.

The dog will prefer to grip the bite body 102 of the motivational object 100, whereby its teeth will slide off the annular bulges 110 and longitudinal webs 112 and are guided into the troughs 114, thereby ensuring a secure hold of the bite body 102 in the muzzle of the dog.

Preferably, the dog returns the motivational object 100 to its handler so that the handler can hurl the motivational object 100 away again.

An alternative use to the game of toss with the motivational object 100 described above is achieved by having the handler hold on to the holding device 106 while the dog is holding on to the bite body 102 with its muzzle.

During the mutual tugging of the motivational object 100, the holding device 106 guarantees that the motivational object 100 does not slip from the handler's hand, and the annular bulges 110 and longitudinal webs 112 guarantee that the dog does not slip from the bite body 102. In particular, the spherical troughs 114 formed by the annular bulges 110 and the longitudinal webs 112 prevent the dog from slipping off of the bite body 102 in any direction.

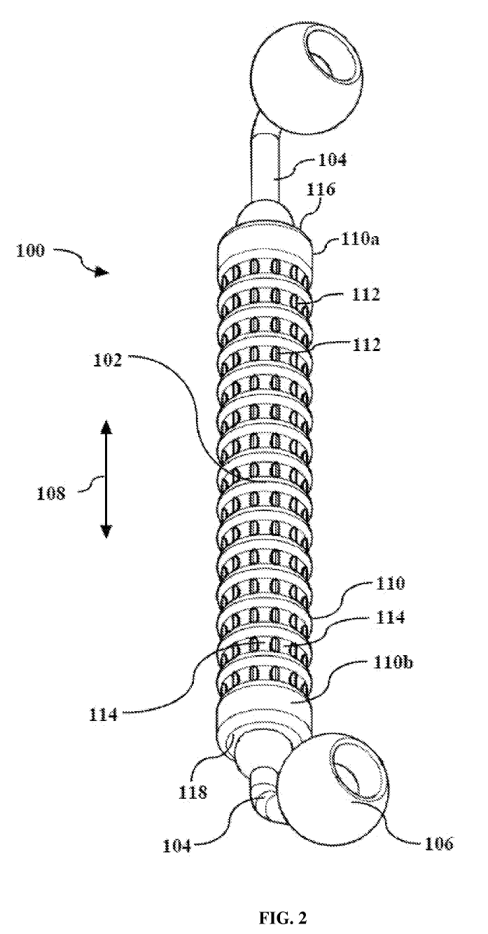

Another implementation example of a motivational object 100 shown in FIG. 2 is different from the embodiment described above as it essentially utilizes a cylindrical bite body 102, and as it has ropes 104 with holding devices 106 provided for on both its basal area 118 and its abutting face 116.

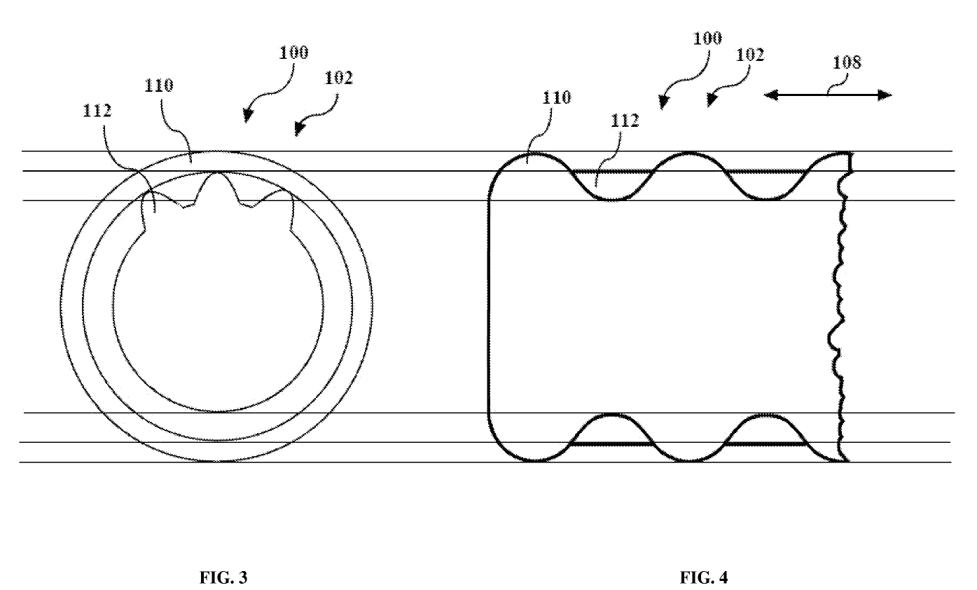

As particularly shown in FIG. 3 and FIG. 4, the second embodiment of the motivational object 100 features longitudinal webs 112 with a smaller radial extension than the annular bulges 110.

Moreover, the embodiments of the motivational object 100 illustrated in FIG. 2 and FIG. 4 coincide with the first embodiment of the motivational object 100 in FIG. 1 both in terms of structure and function, and to which aforementioned descriptions is made reference to in this respect.

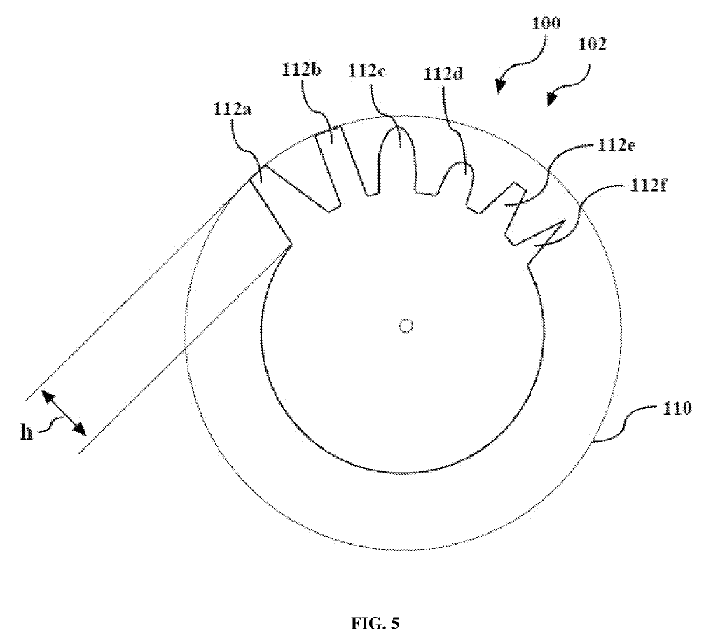

FIG. 5 illustrates different embodiments of longitudinal webs 112.

In principle, the radial expansion of the longitudinal webs 112 relative to the radial expansion of the annular bulges 110 may be chosen freely. However, since increasing the height of the longitudinal webs 112 constructionally also affects the distance between the longitudinal webs 112 and thus moves apart the troughs 114 which serve as possible holding points for a dog, such increase of the height of the longitudinal webs 112 above the height of the annular bulges 110 would be detrimental to the device. This is avoided by providing for a radial expansion of the longitudinal webs 112 that is smaller than the radial expansion of the annular bulges 110.

In particular, it can be provided that the radial expansion of the longitudinal webs 112 is chosen approximately 5 mm smaller than the radial expansion of the annular bulges 110.

The cross sections of preferred embodiments of longitudinal webs 112 illustrated in FIG. 5 are in detail:
One longitudinal web 112a with an essentially trapezoidal shaped cross-section, which is extending in radial direction up to the maximum extension “h” of the annular bulges 110;
One longitudinal web 112b with an essentially rectangular shaped cross-section, which is extending in radial direction up to the maximum extension “h” of the annular bulges 110;
One longitudinal web 112c with an essentially U-shaped cross-section, which is extending in radial direction to approximately 80% of the maximum extension “h” of the annular bulges 110;
One longitudinal web 112d with an essentially U-shaped cross-section, which is extending in radial direction to approximately 50% of the maximum extension “h” of the annular bulges 110;
One longitudinal web 112e with an essentially trapezoidal shaped cross-section, which is extending in radial direction to approximately 60% of the maximum extension “h” of the annular bulges 110;
One longitudinal web 112f with an essentially V-shaped cross-section, which is extending in radial direction to approximately 70% of the maximum extension “h” of the annular bulges 110;

All longitudinal webs 112 illustrated in FIG. 5, as well as longitudinal webs 112 with feature combinations of the longitudinal webs 112 described above, such as radially, in direction of the maximum extension “h” of the annular bulges 110 extending longitudinal webs 112, with essentially U-shaped cross-sections, are all suitable embodiments for the motivational object 100.

Because the circumferential area of the motivational object 100 includes several troughs 114 which are arranged in-between adjacent annular bulges 110a, 110c; 110c, 110d; 110d, 110e; 110e, 110f; and 110f, 110b, an undesirable slipping of the dog off the motivational object 100 is prevented and thus an undisturbed joy of gameplay with the motivational object 100 on one hand, and a flawless dog training experience from a sporting and working dog perspective on the other hand is guaranteed.

I claim:

1. A motivational object for dogs, comprising of a bite body made of an elastomeric material with a first outer annular bulge, a second outer annular bulge and at least one more annular bulge arranged in-between the first outer annular bulge and the outer second annular bulge, whereby the annular bulges are arranged in parallel in the longitudinal direction of the bite body, wherein the circumferential area of the bite body contains a plurality of troughs in-between the adjoining annular bulges.

2. The object according to claim 1, wherein an envelope of the bite body is at least approximately frustoconically shaped.

3. The object according to claim 1, wherein an envelope of the bite body is at least approximately cylindrically shaped.

4. The object according to claim 1, wherein the troughs are formed by the annular bulges and at least one longitudinal web running at least approximately in the longitudinal direction of the bite body.

5. The object according to claim 1, wherein at least sectionally, the annular bulges and at least one longitudinal web are arranged radially in a direction perpendicular to the longitudinal direction of the bite body, having a maximum expansion that is essentially equal in size.

6. The object according to claim 5, wherein the bite body comprises of an essentially uniformly curved outer surface, where at least two annular bulges and at least one longitudinal web are adjoined at the points of their maximum radial extension.

7. The object according to claim 5, wherein at least sectionally, the annular bulges arranged radially in a direction perpendicular to the longitudinal direction of the bite body have an expansion that is larger than at least one longitudinal web.

8. The object according to claim 5, wherein at least sectionally, the annular bulges arranged radially in a direction perpendicular to the longitudinal direction of the bite body have an expansion that is smaller than at least one longitudinal web.

9. The object according to claim 6, wherein at least one longitudinal web is flattened in the area of its maximum radial extent.

10. The object according to claim 6, wherein at least one longitudinal web is pointed-shaped in the area of its maximal radial extent.

11. The object according to claim 6, wherein at least one longitudinal web is rounded off in the area of its maximum radial extent.

12. The object according to claim 4, wherein the bite body includes at least two longitudinal webs which are arranged at a distance of at least approximately 1 mm from each other.

13. The object according to claim 4, wherein the bite body includes at least two longitudinal webs which are arranged at a distance of at most approximately 4 mm from each other.

14. The object according to claim 4, wherein a plurality of essentially symmetrically distributed longitudinal webs are arranged on the bite body.

15. The object according to claim 1, wherein the troughs distributed on the circumferential area of the bite body are arranged in a grid-like configuration.

16. The object according to claim 1, wherein a towing or hurling rope can be arranged at an abutting face of the bite body.

17. The object according to claim 1, wherein the bite body incorporates an essentially concentrically running longitudinal feed-through, through which a towing or hurling rope can be fed.
